(19) United States
(12) Patent Application Publication
(10) Pub. No.: US 2014/0204233 A1
(43) Pub. Date: Jul. 24, 2014

(54) MONOCULAR TELESCOPE CAPABLE OF CAPTURING AND RECORDING IMAGES

(71) Applicant: Tai Ling Liu, Taipei City (TW)

(72) Inventor: Tai Ling Liu, Taipei City (TW)

(21) Appl. No.: 14/157,554

(22) Filed: Jan. 17, 2014

(30) Foreign Application Priority Data
Jan. 24, 2013 (TW) 102201581

(51) Int. Cl. H04N 5/232

(52) U.S. Cl. CPC H04N 5/232
USPC 348/222.1

(57) ABSTRACT

The monocular telescope provided by the present invention includes a monocular main body, an image capturing/recording module and a LCD monitor. The monocular main body includes a tube. An eyepiece end is disposed at a side of the tube, and an objective lens end is disposed at an opposite side of the tube. The image capturing/recording module is disposed inside the monocular main body. An optical image signal captured by a camera lens is converted into an electronic image signal and is transmitted to a control/process module by the image capturing/recording module. The control/process module processes and transmits the electronic image signal in accordance therewith. The LCD monitor is pivotally connected at a side of the monocular main body in such way that the LCD monitor is able to open and close with respect to the tube. The LCD monitor displays images according to the processed electronic image signal.

### CROSS-REFERENCE TO RELATED APPLICATION

This application claims the priority of Taiwanese patent application No. 102201581, filed on Jan. 24, 2013, which is incorporated herewith by reference.

### BACKGROUND OF THE INVENTION

1. Field of the Invention

The present invention relates to a monocular telescope. More particularly, the present invention relates to a monocular telescope having a liquid crystal display (LCD) monitor.

2. The Prior Arts

Based on the differences in structures, telescopes can be mainly categorized into monocular telescopes and binocular telescopes. Typically, the visual image presented through the binocular telescopes is the combined image of the image acquired from the left eye of the user and the image acquired from the right eye of the user. However, since the pupillary distance of every individuals is different (approximately between 50-75 mm), the distance between the left tube and the right tube of the binocular telescope needs to be adjusted accordingly. If the distance between the two tubes of the binocular telescope is not adjusted correctly, the user not only cannot see the image properly, but also may feel dizziness while looking through the binocular telescope. In addition, since the appropriate distance between the pupils and the eyepiece is rather short (approximately smaller than 15 mm), it can be difficult for glasses wearers to have a full clear view (the largest view angle possible through the eyepiece). For those who do not wear glasses, the left and right visual degrees of the eyepiece still need to be adjusted. Hence, if the user is not familiar with the operation of binocular telescopes, it usually requires more time (approximately 20-30 seconds more) to capture a correct and clear image. Although monocular telescopes do not have the above disadvantages when in use; however, monocular telescopes can only be seen through one eye, which can cause other inconveniences.

In order to watch the stars clearly, or to closely observe wild animals in the outdoors, users usually carry telescopes to observe from a distance without disturbing their targets. In this way, users may slowly enjoy every single move of their targets. Some researchers might even bring a monocular telescope that has the function of a digital camera, so they can capture images of the distant object or sceneries observed when they want to.

By the knowledge of the inventor, when observing targets in a distance with a monocular telescope having a camera function, users can press the shutter to capture the desired images instantaneously. For instance, users may capture images of a moment in a sports contest, or a moment when a bird is about to fly. However, since the desired images are usually dynamic images that only last one moment, there are potential risks that the captured images can lose focus.

Because the conventional telescopes having a camera function are not equipped with LCD monitors, users cannot inspect the images captured immediately to see if the images lost focus. For academic researchers or photographers who enjoy shooting wildlife, if the images captured are not in focus, they will not be able to use the images for subsequent studies, since the details in the images cannot be effectively distinguished.

Based on the above reasons, there is an urgent need for the industry to develop a monocular telescope capable of capturing, recording and instantly presenting images.

### SUMMARY OF THE INVENTION

A primary objective of the present invention is to provide a monocular telescope capable of capturing, recording and instantly presenting images.

In order to fulfill the above objectives, the monocular telescope provided by the present invention includes a monocular main body, an image capturing/recording module and a Liquid Crystal Display (LCD) monitor. The monocular main body includes a tube. An eyepiece end is disposed at a side of the tube, and an objective lens end is disposed at an opposite side of the tube. The image capturing/recording module is disposed inside the monocular main body. An optical image signal captured by a camera lens is converted into an electronic image signal and is transmitted to a control/process module by the image capturing/recording module. The control/process module processes and transmits the electronic image signal in accordance therewith. The LCD monitor is pivotally connected at a side of the monocular main body in such way that the LCD monitor is able to open and close with respect to the tube. The LCD monitor displays images according to the processed electronic image signal.

With the monocular telescope provided by the present invention, images can be displayed on the LCD monitor in real time while the monocular telescope is in use. As a result, risks of capturing unfocused images can be lowered effectively, and objects and scenery observed can be precisely documented.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a top view showing a monocular telescope of the present invention;

FIG. 2 is a front view showing the monocular telescope of the present invention;

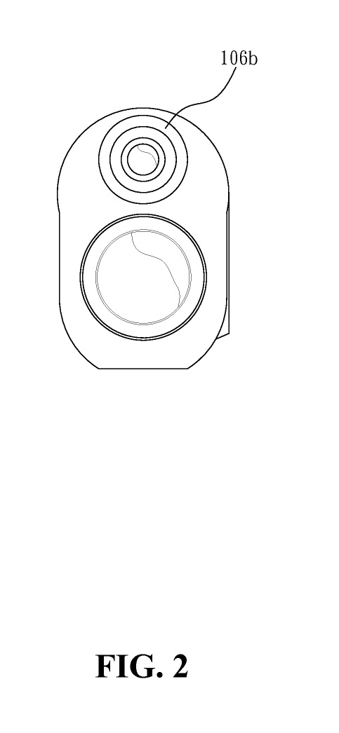

FIG. 3 is a left view showing the monocular telescope of the present invention;

FIG. 4 is a rear view showing the monocular telescope of the present invention;

FIG. 5 is a right view showing the monocular telescope of the present invention;

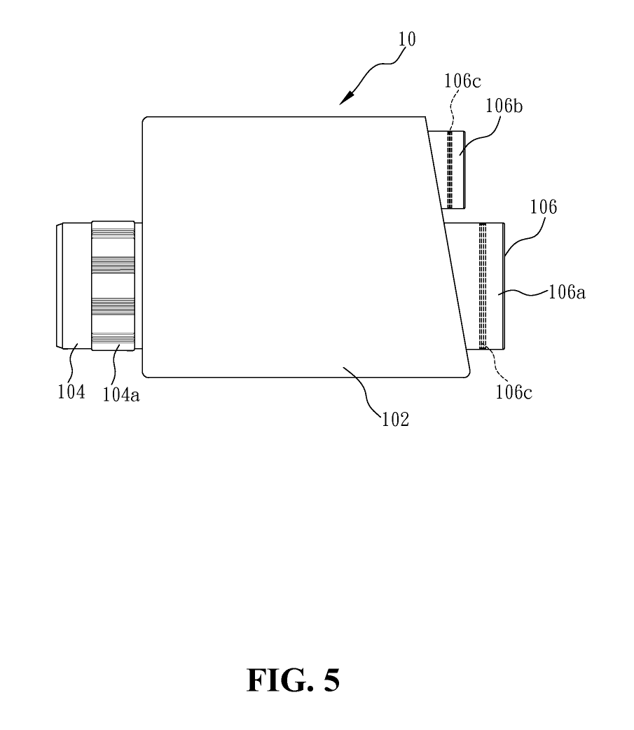

FIG. 6 is a bottom view showing the monocular telescope of the present invention;

FIG. 7 is a top view showing a monocular telescope with a focusing component of the present invention; and

FIG. 8 is the right view showing the monocular telescope of the present invention, wherein the lenses can be replaced freely.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention.

The present invention relates to a monocular telescope capable of capturing and recording images. The monocular telescope provided by the present invention not only can be used as a regular telescope, but can also be used to shoot photos and record videos, including photos and videos with regular definition images and full high-definition (HD) images. In addition, the monocular telescope of the present invention includes a liquid crystal display (LCD) monitor. Images seen through an eyepiece end of the monocular telescope can be presented on the LCD monitor directly. The embodiments of the present invention described hereafter are not meant to limit the application, methods of usage or the environment where the present invention can be used in. Hence, the description for the embodiments of the present invention is for illustrative purpose only, but to limit the scope of the present invention. It is worth mentioning that the components that are not directly related to the present invention are omitted in the drawings. In addition, the drawings of the present invention are not drawn to scale for the sake of simplicity and clarity.

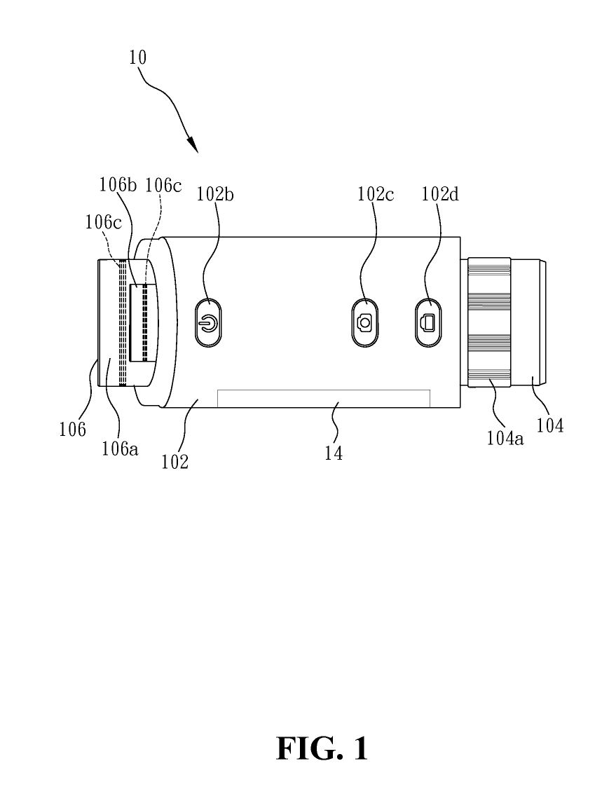

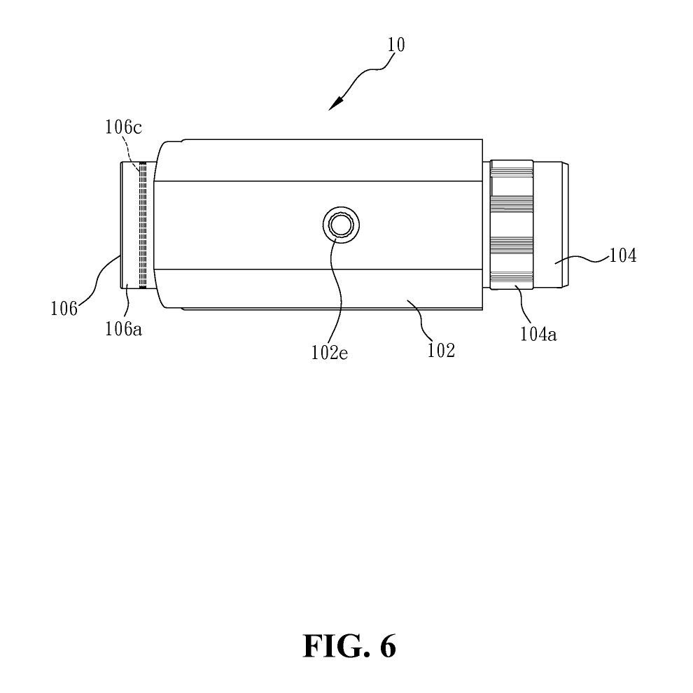

FIG. 1˜FIG. 6 are top view, front view, left view, rear view, right view and bottom view showing the monocular telescope of the present invention, which is capable of capturing and recording images.

As shown in FIG. 1˜FIG. 6, the monocular telescope of the present invention includes a monocular main body 10, an image capturing/recording module 12 (not shown in the drawings) and a liquid crystal display (LCD) monitor 14. Except for capturing, recording, and displaying regular definition images, the present invention can also be equipped with the function to capture, record and display full high-definition (HD) images, depending on the actual implementation.

The monocular main body 10 includes a tube 102. An eyepiece end 104 is disposed at a side of the tube 102, and an objective lens end 106 is disposed at an opposite side of the tube 102. A focusing ring 104a can be disposed at the eyepiece end 104 for adjusting the focus of the image seen through the eyepiece end 104, or for adjusting the visual degree of the user.

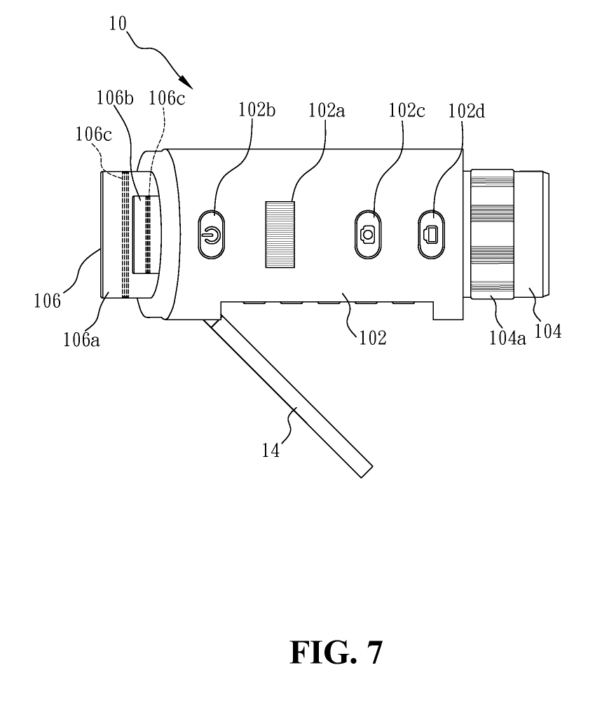

Optionally, as shown in FIG. 7, a focusing component 102a can be disposed on the tube 102. In addition to adjust the focus of the images seen through the eyepiece end 104, the focusing component 102a can also adjust the focus of the images displayed on the LCD monitor 14 in synchronization therewith.

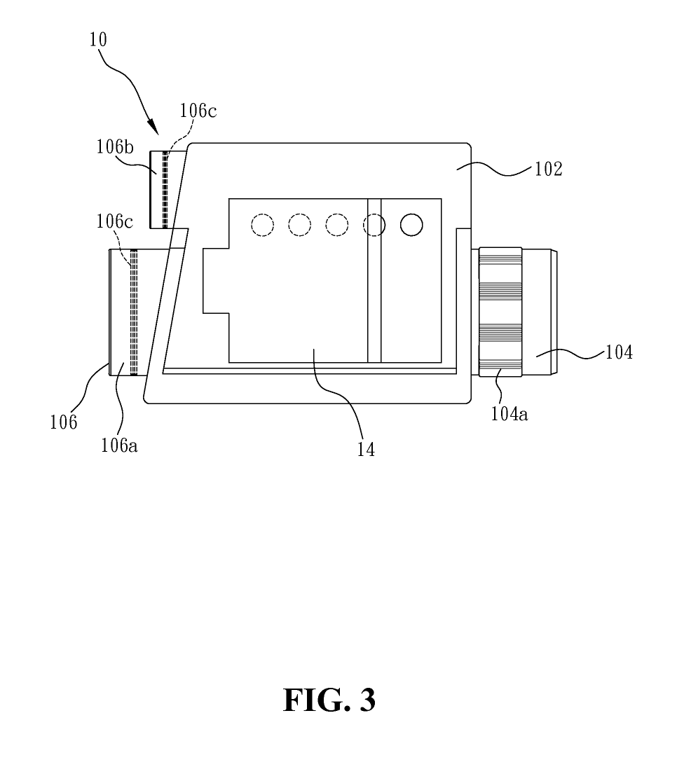

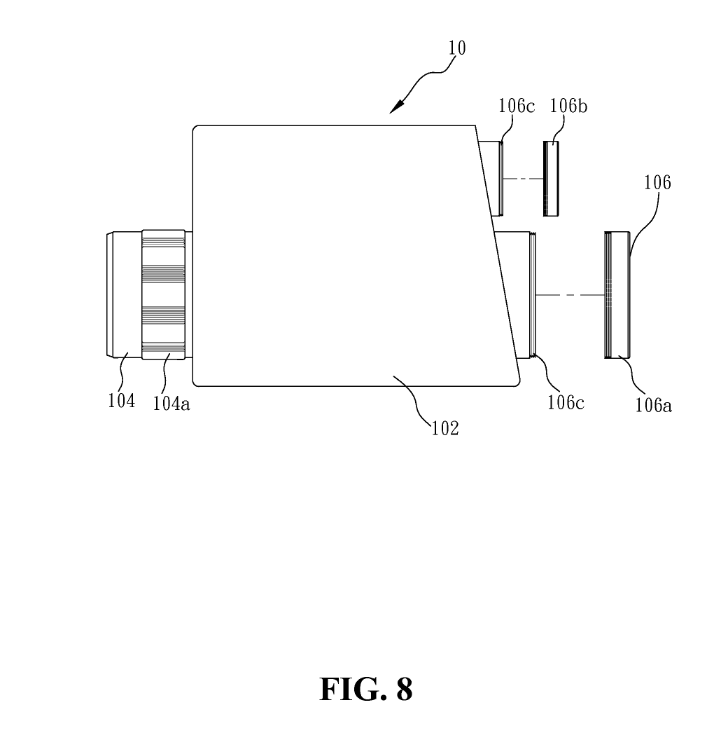

Alternatively, a telephoto lens 106a disposed at the objective lens end 106 of the monocular main body 10 can further include a lens adaptor 106c (as shown in FIG. 3 & FIG. 8). With the lens adaptor 106c, the user may change the optical lenses freely to zoom in/out to adjust the magnification of the optical lenses. Or, the user may swap optical lenses according to the visual effects required. In addition, a camera lens 106b can also include the lens adaptor 106c. With the lens adaptor 106c, the user may change the optical lenses freely to zoom in/out to adjust the magnification of the optical lenses, thereby capturing images as desired. The lens adaptor 106c of the telephoto lens 106a and the lens adaptor 106c of the camera lens 106b can be used cooperatively; in other words, the lens adaptors 106c can be attached with optical lenses with the same function.

The image capturing/recording module 12 (not shown in the drawings) is disposed inside the monocular main body 10. An optical image signal captured by the camera lens 106b is converted into an electronic image signal and is transmitted to a control/process module by the image capturing/recording module. Then, the control/process module processes and transmits the electronic image signal in accordance therewith.

Since the image capturing/recording module 12 has auto-focus function, the images captured or recorded by the image capturing/recording module 12 can be automatically focused and corrected.

The LCD monitor 14 is pivotally connected at a side of the monocular main body 10 in such way that the LCD monitor 14 is able to open and close with respect to the tube 102. The LCD monitor 14 displays images according to the processed electronic image signal.

Optionally, the LCD monitor 14 can include a rotating mechanism. With the rotating mechanism, the LCD monitor 14 is able to rotate freely with respect to the user, so the convenience in using the monocular telescope can be enhanced. In this way, the user or other people can easily see the displayed image by turning the LCD monitor 14 when observing.

It is worth mentioning that the LCD monitor 14 can also be a touch LCD monitor 14. The user can perform operations such as image capturing or video recording by touching the screen.

In addition, the monocular main body 10 can include operation units. FIG. 1 shows an example of the monocular main body 10 with operation units. As shown in FIG. 1, the operation units can include a power button 102b, a photo button 102c and a record button 102d.

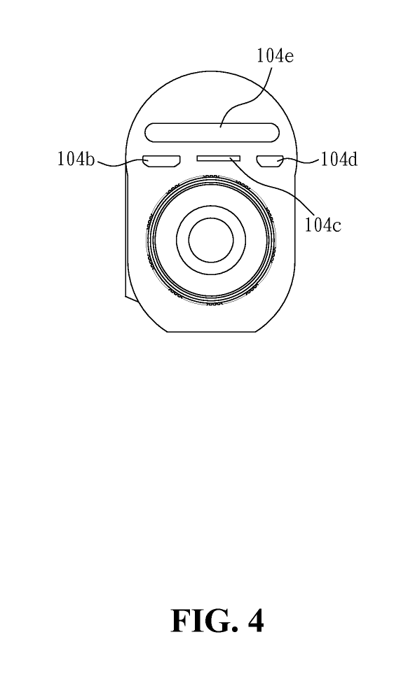

As for the input/output ports, FIG. 4 illustrates a possible configuration. As shown in FIG. 4, the input/output ports can include a High-Definition Multimedia Interface (HDMI) port 104b, a memory card slot 104c, a Universal Serial Bus (USB) port 104d and a battery slot 104e. The USB port 104d can be used for multiple purposes such as charging, data transmission or image transmission.

In addition, the input/output ports are not limited to the ports described above. According to different implementations, the monocular telescope can also include connection ports such as an infrared communication interface, a Bluetooth communication interface, a microphone and a speaker.

Furthermore, it is worth mentioning that the monocular main body 10 can also include a micro-projection module (not shown in the drawings). The micro-projection module projects images according to the processed electronic image signal.

Optionally, similar to the synchronization adjustment of the images displayed on the LCD monitor by the focusing component 102a, the focusing component 102a can also adjust the focus of the image projected by the micro-projection module in synchronization with the adjustment of the focus of the image seen through the eyepiece end 104 of the tube 102.

In addition to the embodiments mentioned above, the monocular main body 10 of the monocular telescope of the present invention can also include a Global Positioning System (GPS) positioning module and a mobile positioning module. In this way, the location where the photos were taken or the location where the videos were recorded can be positioned.

Alternatively, the present invention can also include a wireless network module and a mobile network module. In this way, the monocular telescope of the present invention can have functions such as wireless networking, mobile networking, wireless sharing and wireless file transmitting.

As shown in FIG. 6, a stand mounting hole 102e is disposed at the bottom of the monocular main body 10 for mounting a stand, so the user may operate the monocular telescope more steadily.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A monocular telescope capable of capturing and recording images, comprising:
a monocular main body having a tube, wherein an eyepiece end is disposed at a side of the tube, and an objective lens end is disposed at an opposite side of the tube;
an image capturing/recording module, disposed inside the monocular main body, wherein an optical image signal captured by a camera lens is converted into an electronic image signal and is transmitted to a control/process module by the image capturing/recording module, wherein the control/process module processes and transmits the electronic image signal in accordance therewith; and
a liquid crystal display (LCD) monitor, pivotally connected at a side of the monocular main body in such way that the LCD monitor is able to open and close with respect to the tube, wherein the LCD monitor displays images according to the processed electronic image signal.

2. The monocular telescope according to claim 1, wherein a focusing component is disposed on the tube for adjusting the focus of an image seen through the eyepiece end.

3. The monocular telescope according to claim 1, wherein the LCD monitor includes a rotating mechanism for rotating the LCD monitor with respect to a user.

4. The monocular telescope according to claim 1, wherein the monocular main body further includes an operation unit.

5. The monocular telescope according to claim 1, wherein the monocular main body further includes a High-Definition Multimedia Interface (HDMI) port, a Universal Serial Bus (USB) port, a memory card slot, an infrared communication interface, a Bluetooth communication interface, a microphone and a speaker.

6. The monocular telescope according to claim 2, wherein the monocular main body further includes a micro-projection module.

7. The monocular telescope according to claim 1, wherein the LCD monitor is a touch LCD monitor.

8. The monocular telescope according to claim 1, wherein the monocular main body further includes a Global Positioning System (GPS) positioning module, a mobile positioning module, a wireless network module and a mobile network module.

9. The monocular telescope according to claim 2, wherein the focusing component can adjust the focus of an image shown in the LCD monitor in synchronization with the adjustment of the focus of the image seen through the eyepiece end of the tube.

10. The monocular telescope according to claim 6, wherein the focusing component can also adjust the focus of an image projected by the micro-projection module in synchronization with the adjustment of the focus of the image seen through the eyepiece end of the tube.

11. The monocular telescope according to claim 1, wherein a telephoto lens disposed at the objective lens end and the camera lens both include a lens adaptor for attaching with different optical lenses.
